(19) United States
(12) Patent Application Publication
(10) Pub. No.: US 2012/0304067 A1
(43) Pub. Date: Nov. 29, 2012

(54) APPARATUS AND METHOD FOR CONTROLLING USER INTERFACE USING SOUND RECOGNITION

(75) Inventors: Jae Joon HAN, Seoul (KR); Chang Kyu CHOI, Seongnam-si (KR); Byung In YOO, Seoul (KR)

(73) Assignee: SAMSUNG ELECTRONICS CO., LTD., Suwon-si (KR)

(21) Appl. No.: 13/478,635

(22) Filed: May 23, 2012

(30) Foreign Application Priority Data
May 25, 2011 (KR) 10-2011-0049359
May 4, 2012 (KR) 10-2012-0047215

(51) Int. Cl. G06F 3/16

(52) U.S. Cl. 715/728

(57) ABSTRACT

An apparatus and method for controlling a user interface using sound recognition are provided. The apparatus and method may detect a position of a hand of a user from an image of the user, and may determine a point in time for starting and terminating the sound recognition, thereby precisely classifying the point in time for starting the sound recognition and the point in time for terminating the sound recognition without a separate device. Also, the user may control the user interface intuitively and conveniently.

### CROSS-REFERENCE TO RELATED APPLICATIONS

This application claims the priority benefit of Korean Patent Application No. 10-2011-0049359, filed on May 25, 2011, and Korean Patent Application No. 10-2012-0047215, filed on May 4, 2012, in the Korean Intellectual Property Office, the disclosures of which are incorporated herein by reference.

### BACKGROUND

1. Field

One or more example embodiments of the present disclosure relate to an apparatus and method for controlling a user interface, and more particularly, to an apparatus and method for controlling a user interface using sound recognition.

2. Description of the Related Art

Technology for applying motion recognition and sound recognition to control of a user interface has recently been introduced. However, a method of controlling a user interface using motion recognition, sound recognition, and the like has numerous challenges in determining when a sound and a motion may start, and when the sound and the motion may end. Accordingly, a scheme to indicate the start and the end using a button disposed on a separate device has recently been applied.

However, in the foregoing case, the scheme has a limitation in that it is inconvenient and is not intuitive since the scheme controls the user interface via the separate device, similar to a conventional method that controls the user interface via a mouse, a keyboard, and the like.

### SUMMARY

The foregoing and/or other aspects are achieved by providing an apparatus for controlling a user interface, the apparatus including a reception unit to receive an image of a user from a sensor, a detection unit to detect a position of a face of the user, and a position of a hand of the user, from the received image, a processing unit to calculate a difference between the position of the face and the position of the hand, and a control unit to start sound recognition corresponding to the user when the calculated difference is less than a threshold value, and to control a user interface based on the sound recognition.

The foregoing and/or other aspects are achieved by providing an apparatus for controlling a user interface, the apparatus including a reception unit to receive images of a plurality of users from a sensor, a detection unit to detect positions of faces of each of the plurality of users, and positions of hands of each of the plurality of users, from the received images, a processing unit to calculate differences between the positions of the faces and the positions of the hands, respectively associated with each of the plurality of users, and a control unit to start sound recognition corresponding to a user matched to a difference that may be less than a threshold value when there is a user matched to the difference that may be less than the threshold value, among the plurality of users, and to control a user interface based on the sound recognition.

The foregoing and/or other aspects are achieved by providing an apparatus for controlling a user interface, the apparatus including a reception unit to receive an image of a user from a sensor, a detection unit to detect a position of a face of the user from the received image, and to detect a lip motion of the user based on the detected position of the face, and a control unit to start sound recognition when the detected lip motion corresponds to a lip motion for starting the sound recognition corresponding to the user, and to control a user interface based on the sound recognition.

The foregoing and/or other aspects are achieved by providing an apparatus for controlling a user interface, the apparatus including a reception unit to receive images of a plurality of users from a sensor, a detection unit to detect positions of faces of each of the plurality of users from the received images, and to detect lip motions of each of the plurality of users based on the detected positions of the faces, and a control unit to start sound recognition when there is a user having a lip motion corresponding to a lip motion for starting the sound recognition, among the plurality of users, and to control a user interface based on to the sound recognition.

The foregoing and/or other aspects are achieved by providing a method of controlling a user interface, the method including receiving an image of a user from a sensor, detecting a position of a face of the user, and a position of a hand of the user, from the received image, calculating a difference between the position of the face and the position of the hand, starting sound recognition corresponding to the user when the calculated difference is less than a threshold value, and controlling a user interface based on the sound recognition.

The foregoing and/or other aspects are achieved by providing a method of controlling a user interface, the method including receiving images of a plurality of users from a sensor, detecting positions of faces of each of the plurality of users, and positions of hands of each of the plurality of users, from the received images, calculating differences between the positions of the faces and the positions of the hands, respectively associated with each of the plurality of users, starting sound recognition corresponding to a user matched to a difference that may be less than a threshold value when there is a user matched to the difference that may be less than the threshold value, among the plurality of users, and controlling a user interface based on the sound recognition.

The foregoing and/or other aspects are achieved by providing a method of controlling a user interface, the method including receiving an image of a user from a sensor, detecting a position of a face of the user from the received image, detecting a lip motion of the user based on the detected position of the face, starting sound recognition when the detected lip motion corresponds to a lip motion for starting the sound recognition corresponding to the user, and controlling a user interface based on the sound recognition.

The foregoing and/or other aspects are achieved by providing a method of controlling a user interface, the method including receiving images of a plurality of users from a sensor, detecting positions of faces of each of the plurality of users from the received images, detecting lip motions of each of the plurality of users based on the detected positions of the faces, starting sound recognition when there is a user having a lip motion corresponding to a lip motion for starting the sound recognition, among the plurality of users, and controlling a user interface based on the sound recognition.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a configuration of an apparatus for controlling a user interface according to example embodiments;

FIG. 2 illustrates an example in which a sensor may be mounted in a mobile device according to example embodiments;

FIG. 3 illustrates a visual indicator according to example embodiments;

FIG. 4 illustrates a method of controlling a user interface according to example embodiments;

FIG. 5 illustrates a method of controlling a user interface corresponding to a plurality of users according to example embodiments;

FIG. 6 illustrates a method of controlling a user interface in a case in which a sensor may be mounted in a mobile device according to example embodiments; and

FIG. 7 illustrates a method of controlling a user interface in a case in which a sensor may be mounted in a mobile device, and a plurality of users may be photographed according to example embodiment.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

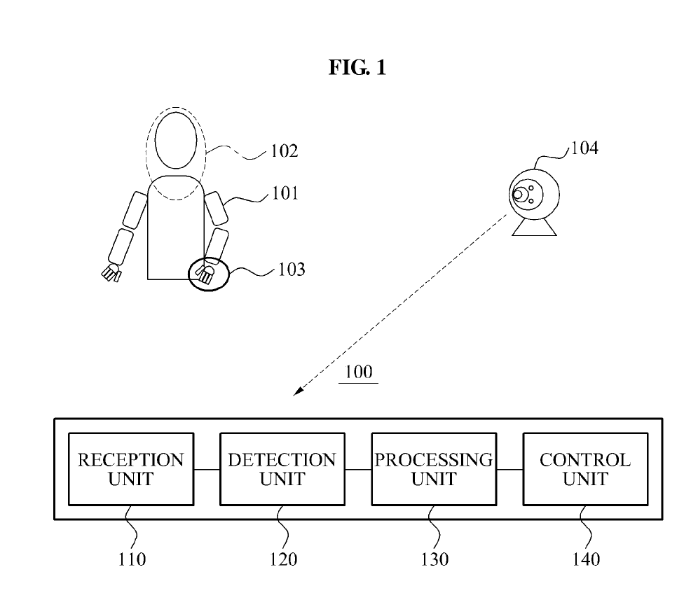

FIG. 1 illustrates a configuration of an apparatus 100 for controlling a user interface according to example embodiments.

Referring to FIG. 1, the apparatus 100 may include a reception unit 110, a detection unit 120, a processing unit 130, and a control unit 140.

The reception unit 110 may receive an image of a user 101 from a sensor 104.

The sensor 104 may include a camera, a motion sensor, and the like. The camera may include a color camera that may photograph a color image, a depth camera that may photograph a depth image, and the like. Also, the camera may correspond to a camera mounted in a mobile communication terminal, a portable media player (PMP), and the like.

The image of the user 101 may correspond to an image photographed by the sensor 104 with respect to the user 101, and may include a depth image, a color image, and the like.

The control unit 140 may output one of a gesture and a posture for starting sound recognition to a display apparatus associated with a user interface before the sound recognition begins. Accordingly, the user 101 may easily verify how to pose or a gesture to make in order to start the sound recognition. Also, when the user 101 wants to start the sound recognition, the user 101 may enable the sound recognition to be started at a desired point in time by imitating the gesture or the posture output to the display apparatus. In this instance, the sensor 104 may sense an image of the user 101, and the reception unit 110 may receive the image of the user 101 from the sensor 104.

The detection unit 120 may detect a position of a face 102 of the user 101, and a position of a hand 103 of the user 101, from the image of the user 101 received from the sensor 104.

For example, the detection unit 120 may detect, from the image of the user 101, at least one of the position of the face 102, an orientation of the face 102, a position of lips, the position of the hand 103, a posture of the hand 103, and a position of a device in the hand 103 of the user 101 when the user 101 holds the device in the hand 103. An example of information regarding the position of the face 102 of the user 101, and the position of the hand 103 of the user 101, detected by the detection unit 120, is expressed in the following by Equation 1:

V_{f}={Faceₚₒₛᵢₜᵢₒₙ, Faceₒᵣᵢₑₙₜₐₜᵢₒₙ, Faceₗᵢₚₛ, Handₚₒₛᵢₜᵢₒₙ, Handₚₒₛₜᵤᵣₑ, HandHeldDeviceₚₒₛᵢₜᵢₒₙ}. Equation 1

The detection unit 120 may extract a feature from the image of the user 101 using Haar detection, the modified census transform, and the like, learn a classifier such as Adaboost, and the like using the extracted feature, and detect the position of the face 102 of the user 101 using the learned classifier. However, a face detection operation performed by the detection unit 120 to detect the position of the face 102 of the user 101 is not limited to the aforementioned scheme, and the detection unit 120 may perform the face detection operation by applying schemes other than the aforementioned scheme.

The detection unit 120 may detect the face 102 of the user 101 from the image of the user 101, and may either calculate contours of the detected face 102 of the user 101, or may calculate a centroid of the entire face 102. In this instance, the detection unit 120 may calculate the position of the face 102 of the user 101 based on the calculated contours or centroid.

For example, when the image of the user 101 received from the sensor 104 corresponds to a color image the detection unit 120 may detect the position of the hand 103 of the user 101 using a skin color, Haar detection, and the like. When the image of the user 101 received from the sensor 104 corresponds to a depth image, the detection unit 120 may detect the position of the hand 103 using a conventional algorithm for detecting a depth image.

The processing unit 130 may calculate a difference between the position of the face 102 of the user 101 and the position of the hand 103 of the user 101.

The control unit 140 may start sound recognition corresponding to the user 101 when the calculated difference between the position of the face 102 and the position of the hand 103 is less than a threshold value. In this instance, the operation of the control unit 140 is expressed in the following by Equation 2:

IF Faceₚₒₛᵢₜᵢₒₙ−Handₚₒₛᵢₜᵢₒₙ<T_{distance} THEN Activation(S_{f}). Equation 2

Here, Faceₚₒₛᵢₜᵢₒₙ denotes the position of the face 102, Handₚₒₛᵢₜᵢₒₙ denotes the position of the hand 103, T_{distance} denotes the threshold, and Activation(S_{f}) denoted activation of the sound recognition.

Accordingly, when a distance between the calculated position of the face 102 and the calculated position of the hand 103 is greater than the threshold value, the control unit 140 may delay the sound recognition corresponding to the user 101.

Here, the threshold value may be predetermined Also, the user 101 may determine the threshold value by inputting the threshold value in the apparatus 100.

The control unit 140 may terminate the sound recognition with respect to the user 101 when a sound signal fails to be input by the user 101 within a predetermined time period.

The reception unit 110 may receive a sound of the user 101 from the sensor 104. In this instance, the control unit 140 may start sound recognition corresponding to the received sound when the difference between the calculated position of the face 102 and the calculated position of the hand 103 is less than the threshold value. Thus, a start point of the sound recognition for controlling the user interface may be precisely classified according to the apparatus 100.

An example of information regarding the sound received by the reception unit 110 is expressed in the following by Equation 3:

S_{f}={SCommand₁, SCommand₂, . . . SCommandₙ}. Equation 3

The detection unit 120 may detect a posture of the hand 103 of the user 101 from the image received from the sensor 104.

For example, the detection unit 120 may perform signal processing to extract a feature of the hand 103 using a depth camera, a color camera, or the like, learn a classifier with a pattern related to a particular hand posture, extract an image of the hand 103 from the obtained image, extract a feature, and classify the extracted feature as a hand posture pattern having the highest probability. However, an operation performed by the detection unit 120 to classify the hand posture pattern is not limited to the aforementioned scheme, and the detection unit 120 may perform the operation to classify the hand posture pattern by applying schemes other than the aforementioned scheme.

The control unit 140 may start sound recognition corresponding to the user 101 when the calculated difference between the position of the face 102 and the position of the hand 103 is less than a threshold value, and the posture of the hand 103 corresponds to a posture for starting the sound recognition. In this instance, the operation of the control unit 140 is expressed in the following by Equation 4:

IF Faceₚₒₛᵢₜᵢₒₙ−Handₚₒₛᵢₜᵢₒₙ<T_{distance} AND Handₚₒₛₜᵤᵣₑ=H_{Command} THEN Activation(Sf). Equation 4

Here, Handₚₒₛᵢₜᵢₒₙ denotes the position of the hand 103, and H_{command} denotes the posture for starting the sound recognition.

The control unit 140 may terminate the sound recognition when the detected posture of the hand 103 corresponds to a posture for terminating the sound recognition. That is, the reception unit 110 may receive the image of the user 101 from the sensor 104 continuously, after the sound recognition is started. Also, the detection unit 120 may detect the posture of the hand 103 of the user 101 from the image received after the sound recognition is started. In this instance, the control unit 140 may terminate the sound recognition when the detected posture of the hand 103 of the user 101 corresponds to a posture for terminating the sound recognition.

The control unit 140 may output the posture for terminating the sound recognition to the display apparatus associated with the user interface after the sound recognition is started. Accordingly, the user 101 may easily verify how to pose in order to terminate the sound recognition. Also, when the user 101 wants to terminate the sound recognition, the user 101 may enable the sound recognition to be terminated by imitating the posture of the hand that is output to the display apparatus. In this instance, the sensor 104 may sense an image of the user 101, and the detection unit 120 may detect the posture of the hand 103 from the image of the user 101 sensed and received. Also, the control unit 140 may terminate the sound recognition when the detected posture of the hand 103 corresponds to the posture for terminating the sound recognition.

Here, the posture for starting the sound recognition and the posture for terminating the sound recognition may be predetermined. Also, the user 101 may determine the posture for starting the sound recognition and the posture for terminating the sound recognition by inputting the postures in the apparatus 100.

The detection unit 120 may detect a gesture of the user 101 from the image received from the sensor 104.

The detection unit 120 may perform signal processing to extract a feature of the user 101 using a depth camera, a color camera, or the like. A classifier may be learned with a pattern related to a particular gesture of the user 101. An image of the user 101 may be extracted from the obtained image, and the feature may be extracted. The extracted feature may be classified as a gesture pattern having the highest probability. However, an operation performed by the detection unit 120 to classify the gesture pattern is not limited to the aforementioned scheme, and the operation of classifying the gesture pattern may be performed by applying schemes other than the aforementioned scheme.

In this instance, the control unit 140 may start the sound recognition corresponding to the user 101 when a calculated difference between a position of the face 102 and a position of the hand 103 is less than a threshold value, and the gesture of the user 101 corresponds to a gesture for starting the sound recognition.

Also, the control unit 140 may terminate the sound recognition when the detected gesture of the user 101 corresponds to a gesture for terminating the sound recognition. That is, the reception unit 110 may receive the image of the user 101 from the sensor 104 continuously after the sound recognition is started. Also, the detection unit 120 may detect the gesture of the user 101 from the image received after the sound recognition is started. In this instance, the control unit 140 may terminate the sound recognition when the detected gesture of the user 101 corresponds to the gesture for terminating the sound recognition.

In addition, the control unit 140 may output the gesture for terminating the sound recognition to the display apparatus associated with the user interface after the sound recognition is started. Accordingly, the user 101 may easily verify a gesture to be made in order to terminate the sound recognition. Also, when the user 101 wants to terminate the sound recognition, the user 101 may enable the sound recognition to be terminated by imitating the gesture that is output to the display apparatus. In this instance, the sensor 104 may sense an image of the user 101, and the detection unit 120 may detect the gesture of the user 101 from the image of the user 101 sensed and received. Also, the control unit 140 may terminate the sound recognition when the detected gesture of the user 101 corresponds to the gesture for terminating the sound recognition.

Here, the gesture for starting the sound recognition and the gesture for terminating the sound recognition may be predetermined. Also, the user 101 may determine the gesture for starting the sound recognition and the gesture for terminating the sound recognition by inputting the gestures in the apparatus 100.

The processing unit 130 may calculate a distance between the position of the face 102 and the sensor 104. Also, the control unit 140 may start the sound recognition corresponding to the user 101 when the distance between the position of the face 103 and the sensor 104 is less than a threshold value. In this instance, the operation of the control unit 140 is expressed in the following by Equation 5:

IF Faceₒᵣᵢₑₙₜₐₜᵢₒₙ−Cameraₒᵣᵢₑₙₜₐₜᵢₒₙ<Tₒᵣᵢₑₙₜₐₜᵢₒₙ THEN Activation(S_{f}). Equation 5

For example, when the user 101 holds a device in the hand 103, the processing unit 130 may calculate a distance between the position of the face 102, and the device held in the hand 103. Also, the control unit 140 may start the sound recognition corresponding to the user 101 when the distance between the position of the face 102, and the device held in the hand 103 is less than a threshold value. In this instance, the operation of the control unit 140 is expressed in the following by Equation 6:

IF Faceₚₒₛᵢₜᵢₒₙ HandHeldDeviceₚₒₛᵢₜᵢₒₙ<T_{distance} THEN Activation(S_{f}). Equation 6

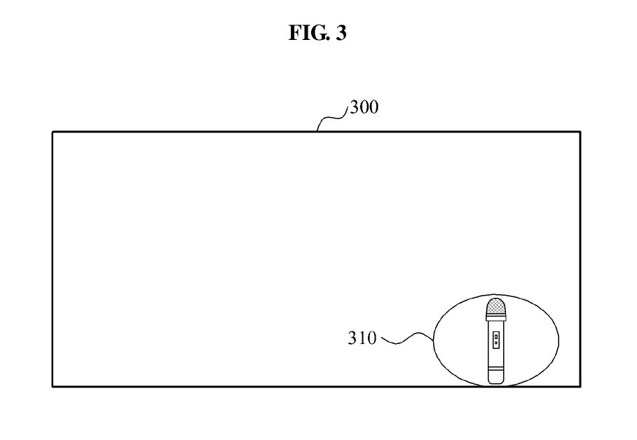

The control unit 140 may output a visual indicator corresponding to the sound recognition to a display apparatus associated with the user interface, and may start the sound recognition when the visual indicator is output to the display apparatus. An operation performed by the control unit 140 to output the visual indicator will be further described hereinafter with reference to FIG. 3.

FIG. 3 illustrates a visual indicator 310 according to example embodiments.

Referring to FIG. 3, the control unit 140 of the apparatus 100, may output the visual indicator 310 to a display apparatus 300 before starting sound recognition corresponding to the user 101. In this instance, when the visual indicator 310 is output to the display apparatus 300, the control unit 140 may start the sound recognition corresponding to the user 101. Accordingly, the user 101 may be able to visually identify that the sound recognition is started.

Referring back to FIG. 1, the control unit 140 may control the user interface based on the sound recognition when the sound recognition is started.

An operation of the apparatus 100 in a case of a plurality of users will be further described hereinafter.

In the case of the plurality of users, the sensor 104 may photograph the plurality of users. The reception unit 110 may receive images of the plurality of users from the sensor 104. For example, when the sensor 104 photographs three users, the reception unit 110 may receive images of the three users.

The detection unit 120 may detect positions of faces of each of the plurality of users, and positions of hands of each of the plurality of users, from the received images. For example, the detection unit 120 may detect, from the received images, a position of a face of a first user and a position of a hand of the first user, a position of a face of a second user and a position of a hand of the second user, and a position of a face of a third user and a position of a hand of the third user, among the three users.

The processing unit 130 may calculate differences between the positions of the faces and the positions of the hands, respectively associated with each of the plurality of users. For example, the processing unit 130 may calculate a difference between the position of the face of the first user and the position of the hand of the first user, a difference between the position of the face of the second user and the position of the hand of the second user, and a difference between the position of the face of the third user and the position of the hand of the third user.

When there is a user matched to a difference that may be less than a threshold value, among the plurality of users, the control unit 140 may start sound recognition corresponding to the user matched to the difference that may be less than the threshold value. Also, the control unit 140 may control the user interface based on the sound recognition corresponding to the user matched to the difference that may be less than the threshold value. For example, when the difference between the position of the face of the second user and the position of the hand of the second user, among the three users, is less than the threshold value, the control unit 140 may start sound recognition corresponding to the second user. Also, the control unit 140 may control the user interface based on the sound recognition corresponding to the second user.

The reception unit 110 may receive sounds of a plurality of users from the sensor 104. In this instance, the control unit 140 may segment, from the received sounds, a sound of the user matched to the calculated difference that may be less than the threshold value, based on at least one of the positions of the faces, and the positions of the hands, detected in association with each of the plurality of users. The control unit 140 may extract an orientation of the user matched to the calculated difference that may be less than the threshold value, and segment a sound from the orientation extracted from the sounds received from the sensor 104, using at least one of the detected position of the face, and the detected position of the hand. For example, when the difference between the position of the face of the second user and the position of the hand of the second user, among the three users, is less than the threshold value, the control unit 140 may extract an orientation of the second user based on the position of the face of the second user and the position of the hand of the second user, and may segment a sound from the orientation extracted from the sounds received from the sensor 104, thereby segmenting the sound of the second user.

In this instance, the control unit 140 may control the user interface based on the segmented sound. Accordingly, in the case of the plurality of users, the control unit 140 may control the user interface by identifying a main user who controls the user interface.

The apparatus 100 may further include a database.

The database may store a sound signature of the main user who controls the user interface.

In this instance, the reception unit 110 may receive sounds of a plurality of users from the sensor 104.

Also, the control unit 140 may segment a sound corresponding to the sound signature from the received sounds. The control unit 140 may control the user interface based on the segmented sound. Accordingly, in the case of the plurality of users, the control unit 140 may control the user interface by identifying the main user who controls the user interface.

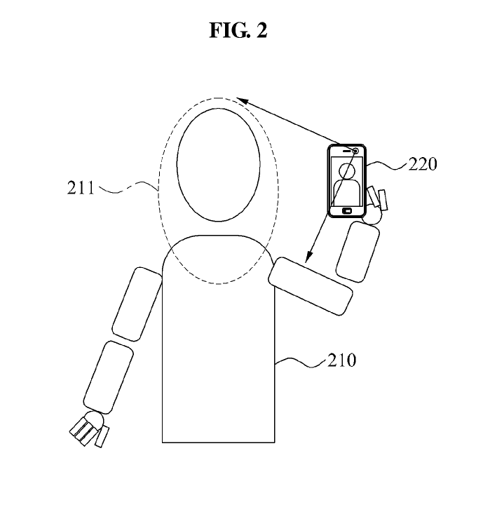

FIG. 2 illustrates an example in which a sensor may be mounted in a mobile device 220 according to example embodiments.

Referring to FIG. 2, the sensor may be mounted in the mobile device 220 in a modular form.

In this instance, the sensor mounted in the mobile device 220 may photograph a face 211 of a user 210, however, may be incapable of photographing a hand of the user 210 in some cases.

An operation of the apparatus for controlling a user interface, in a case where the hand of the user 210 may be excluded from the image of the user 210 photographed by the sensor mounted in the mobile device 220 in the modular form, will be further described hereinafter.

A reception unit may receive an image of the user 210 from the sensor.

As an example, a detection unit may detect a position of the face 211 of the user 210 from the received image. Also, the detection unit may detect a lip motion of the user 210 based on the detected position of the face 211.

When the lip motion corresponds to a lip motion for starting sound recognition corresponding to the user 210, a control unit may start the sound recognition.

The lip motion for starting the sound recognition may be predetermined. Also, the user 210 may determine the lip motion for starting the sound recognition by inputting the lip motion in the apparatus for controlling the user interface.

When a change in the detected lip motion is sensed, the control unit may start the sound recognition. For example, when an extent of the change in the lip motion exceeds a predetermined criterion value, the control unit may start the sound recognition.

The control unit may control the user interface based on the sound recognition.

Also, an operation of the apparatus for controlling a user interface, in a case where hands of a plurality of users may be excluded in images of the plurality of users photographed by the sensor mounted in the mobile device 220 in the modular form, will be further described hereinafter.

A reception unit may receive images of the plurality of users from the sensor. For example, when the sensor photographs three users, the reception unit may receive images of the three users.

A detection unit may detect positions of faces of each of the plurality of users from the received images. For example, the detection unit may detect, from the received images, a position of a face of a first user, a position of a face of a second user, and a position of a face of a third user, among the three users.

Also, the detection unit may detect lip motions of each of the plurality of users based on the detected positions of the faces. For example, the detection unit may detect a lip motion of the first user from the detected position of the face of the first user, a lip motion of the second user from the detected position of the face of the second user, and a lip motion of the third user from the detected position of the face of the third user.

When there exists a user having a lip motion corresponding to a lip motion for starting sound recognition, among the plurality of users, a control unit may start the sound recognition. For example, when the lip motion of the second user, among the three users, corresponds to the lip motion for starting the sound recognition, the control unit may start the sound recognition corresponding to the second user. Also, the control unit may control the user interface based on the sound recognition corresponding to the second user.

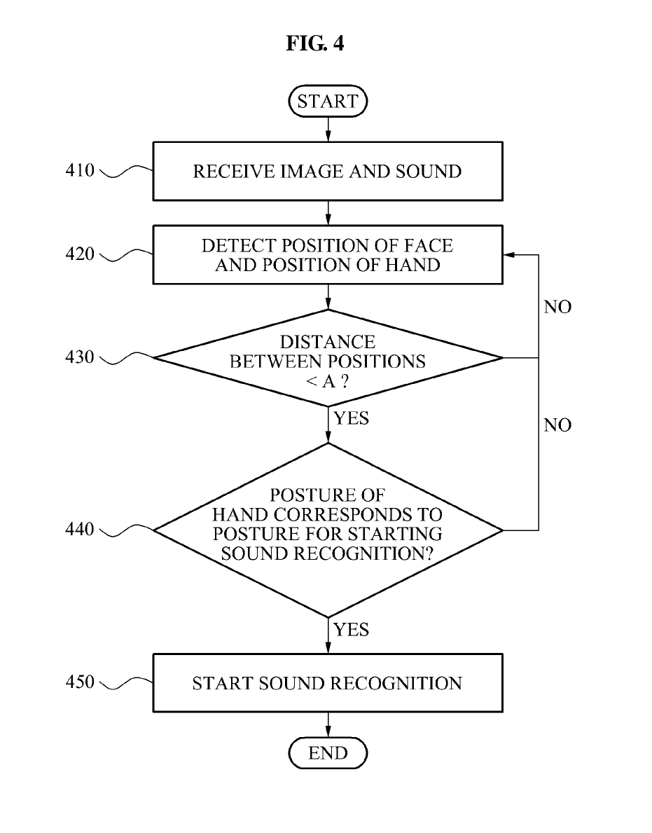

FIG. 4 illustrates a method of controlling a user interface according to example embodiments.

Referring to FIG. 4, an image of a user may be received from a sensor in operation 410.

The sensor may include a camera, a motion sensor, and the like. The camera may include a color camera that may photograph a color image, a depth camera that may photograph a depth image, and the like. Also, the camera may correspond to a camera mounted in a mobile communication terminal, a portable media player (PMP), and the like.

The image of the user may correspond to an image photographed by the sensor with respect to the user, and may include a depth image, a color image, and the like.

In the method of controlling the user interface, one of a gesture and a posture for starting sound recognition may be output to a display apparatus associated with a user interface before the sound recognition is started. Accordingly, the user may easily verify how to pose or a gesture to make in order to start the sound recognition. Also, when the user wants to start the sound recognition, the user may enable the sound recognition to be started at a desired point in time by imitating the gesture or the posture output to the display apparatus. In this instance, the sensor may sense an image of the user, and the image of the user may be received from the sensor.

In operation 420, a position of a face of the user and a position of a hand of the user may be detected from the image of the user received from the sensor.

For example, at least one of the position of the face, an orientation of the face, a position of lips, the position of the hand, a posture of the hand, and a position of a device in the hand of the user when the user holds the device in the hand may be detected from the image of the user.

A feature may be extracted from the image of the user, using Haar detection, the modified census transform, and the like, a classifier such as Adaboost, and the like may be learned using the extracted feature, and the position of the face of the user may be detected using a learned classifier. However, a face detection operation performed by the method of controlling the user interface to detect the position of the face of the user is not limited to the aforementioned scheme, and the method of controlling the user interface may perform the face detection operation by applying schemes other than the aforementioned scheme.

The face of the user may be detected from the image of the user, and either contours of the detected face of the user, or a centroid of the entire face may be calculated. In this instance, the position of the face of the user may be calculated based on the calculated contours or centroid.

When the image of the user received from the sensor corresponds to a color image, the position of the hand of the user may be detected using a skin color, Haar detection, and the like. When the image of the user received from the sensor corresponds to a depth image, the position of the hand may be detected using a conventional algorithm for detecting to a depth image.

In operation 430, a difference between the position of the face of the user and the position of the hand of the user may be calculated.

In operation 450, sound recognition corresponding to the user may start when the calculated difference between the position of the face and the position of the hand is less than to a threshold value.

Accordingly, when a distance between the calculated position of the face and the calculated position of the hand is greater than the threshold value, the sound recognition corresponding to the user may be delayed.

Here, the threshold value may be predetermined. Also, the user may determine the threshold value by inputting the threshold value in the apparatus of controlling a user interface.

In the method of controlling the user interface, the sound recognition corresponding to the user may be terminated when a sound signal fails to be input by the user within a predetermined time period.

A sound of the user may be received from the sensor. In this instance, sound recognition corresponding to the received sound may start when the difference between the calculated position of the face and the calculated position of the hand is less than the threshold value. Thus, a start point of the sound recognition for controlling the user interface may be precisely classified according to the method of controlling the user interface.

A posture of the hand of the user may be detected from the image received from the sensor in operation 440.

For example, signal processing may be performed to extract a feature of the hand using a depth camera, a color camera, or the like. A classifier may be learned with a pattern related to a particular hand posture. An image of the hand may be extracted from the obtained image, and the feature may be extracted. The extracted feature may be classified as a hand posture pattern having the highest probability. However, according to the method of controlling the user interface, an operation of classifying the hand posture pattern is not limited to the aforementioned scheme, and the operation of classifying the hand posture to pattern may be performed by applying schemes other than the aforementioned scheme.

Sound recognition corresponding to the user may start when the calculated difference between the position of the face and the position of the hand is less than a threshold value, and the posture of the hand corresponds to a posture for starting the sound recognition.

The sound recognition may be terminated when the detected posture of the hand corresponds to a posture for terminating the sound recognition. That is, the image of the user may be received from the sensor continuously, after the sound recognition is started. Also, the posture of the hand of the user may be detected from the image received after the sound recognition is started. In this instance, the sound recognition may be terminated when the detected posture of the hand of the user corresponds to a posture for terminating the sound recognition.

The posture for terminating the sound recognition may be output to the display apparatus associated with the user interface after the sound recognition is started. Accordingly, the user may easily verify how to pose in order to terminate the sound recognition. Also, when the user wants to terminate the sound recognition, the user may enable the sound recognition to be terminated by imitating the posture of the hand that is output to the display apparatus. In this instance, the sensor may sense an image of the user, and the posture of the hand may be detected from the image of the user sensed and received. Also, the sound recognition may be terminated when the detected posture of the hand corresponds to the posture for terminating the sound recognition.

The posture for starting the sound recognition and the posture for terminating the sound recognition may be predetermined. Also, the user may determine the posture for starting the sound recognition and the posture for terminating the sound recognition, by inputting the postures in the apparatus of controlling a user interface.

A gesture of the user may be detected from the image received from the sensor.

Signal processing to extract a feature of the user may be performed using a depth camera, a color camera, or the like. A classifier may be learned with a pattern related to a particular gesture of the user. An image of the user may be extracted from the obtained image, and the feature may be extracted. The extracted feature may be classified as a gesture pattern having the highest probability. However, an operation of classifying the gesture pattern is not limited to the aforementioned scheme, and the operation of classifying the gesture pattern may be performed by applying schemes other than the aforementioned scheme.

In this instance, the sound recognition corresponding to the user may be started when a calculated difference between a position of the face and a position of the hand is less than a threshold value, and the gesture of the user corresponds to a gesture for starting the sound recognition.

Also, the sound recognition may be terminated when the detected gesture of the user corresponds to a gesture for terminating the sound recognition. That is, the image of the user may be received from the sensor continuously, after the sound recognition is started. Also, the gesture of the user may be detected from the image received after the sound recognition is started. In this instance, the sound recognition may be terminated when the detected gesture of the user corresponds to the gesture for terminating the sound recognition.

In addition, the gesture for terminating the sound recognition may be output to the display apparatus associated with the user interface after the sound recognition is started.

Accordingly, the user may easily verify a gesture to be made in order to terminate the sound recognition. Also, when the user wants to terminate the sound recognition, the user may enable the sound recognition to be terminated by imitating the gesture that is output to the display apparatus. In this instance, the sensor may sense an image of the user, and the gesture of the user may be detected from the image of the user sensed and received. Also, the sound recognition may be terminated when the detected gesture of the user corresponds to the gesture for terminating the sound recognition.

Here, the gesture for starting the sound recognition and the gesture for terminating the sound recognition may be predetermined. Also, the user may determine the gesture for starting the sound recognition and the gesture for terminating the sound recognition by inputting the gestures.

A distance between the position of the face and the sensor may be calculated. Also, the sound recognition corresponding to the user may start when the distance between the position of the face and the sensor is less than a threshold value.

For example, when the user holds a device in the hand, a distance between the position of the face, and the device held in the hand may be calculated. Also, the sound recognition corresponding to the user may start when the distance between the position of the face, and the device held in the hand is less than a threshold.

A visual indicator corresponding to the sound recognition may be output to a display apparatus associated with the user interface, and the sound recognition may start when the visual indicator is output to the display apparatus. Accordingly, the user may be able to visually identify that the sound recognition starts.

Thereby, when the sound recognition starts, the user interface may be controlled based on the sound recognition.

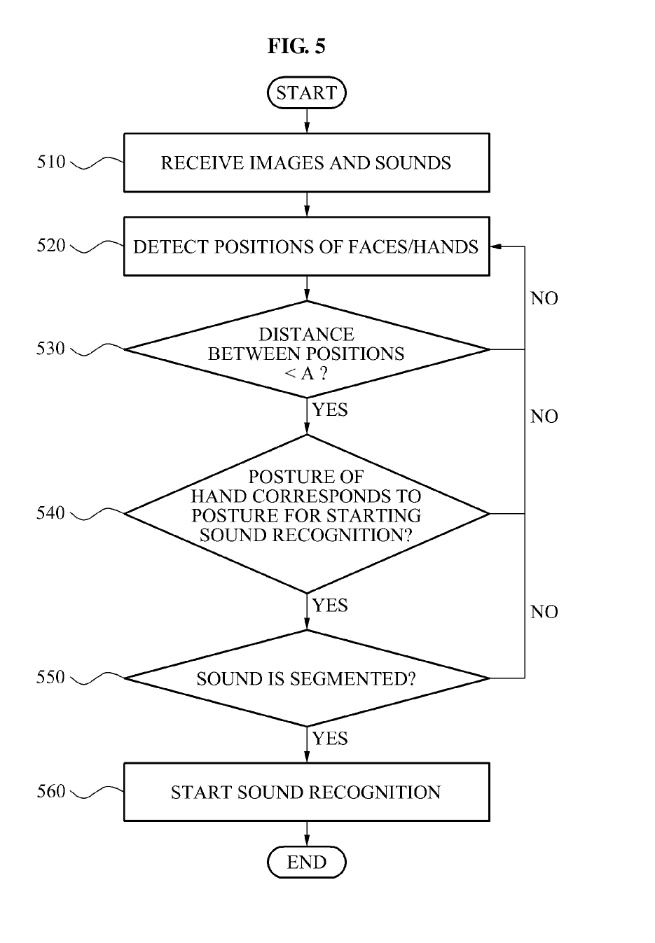

FIG. 5 illustrates a method of controlling a user interface corresponding to a plurality of users according to example embodiments.

Referring to FIG. 5, in the case of the plurality of users, the plurality of users may be photographed by a sensor. In operation 510, the photographed images of the plurality of users may be received from the sensor. For example, when the sensor photographs three users, images of the three users may be received.

In operation 520, positions of faces of each of the plurality of users, and positions of hands of each of the plurality of users may be detected from the received images. For example, a position of a face of a first user and a position of a hand of the first user, a position of a face of a second user and a position of a hand of the second user, and a position of a face of a third user and a position of a hand of the third user, among the three users may be detected from the received images.

In operation 530, respective differences between the positions of the faces and the positions of the hands may be calculated and respectively associated with each of the plurality of users. For example, a difference between the position of the face of the first user and the position of the hand of the first user, a difference between the position of the face of the second user and the position of the hand of the second user, and a difference between the position of the face of the third user and the position of the hand of the third user may be calculated.

When there is a user matched to a difference that may be less than a threshold value, among the plurality of users, sound recognition corresponding to the user matched to the difference that may be less than the threshold value may start in operation 560. Also, the user interface may be controlled based on the sound recognition corresponding to the user matched to the difference that may be less than the threshold value. For example, when the difference between the position of the face of the second user and the position of the hand of the second user, among the three users, is less than the threshold value, sound recognition corresponding to the second user may start. Also, the user interface may be controlled based on the sound recognition corresponding to the second user.

A posture of the hand of the user may be detected from the image received from the sensor. In this instance, sound recognition corresponding to the user may start when the calculated difference between the position of the face and the position of the hand is less than a threshold value, and the posture of the hand corresponds to a posture for starting the sound recognition.

Sounds of a plurality of users may be received from the sensor. In this instance, a sound of the user matched to the calculated difference that may be less than the threshold value may be segmented from the received sounds, based on at least one of the positions of the faces, and the positions of the hands, detected in association with each of the plurality of users. In operation 550, an orientation of the user matched to the calculated difference that may be less than the threshold value may be extracted, and a sound may be segmented from the orientation extracted from the sounds received from the sensor, based on at least one of the detected position of the face, and the detected position of the hand. For example, when the difference between the position of the face of the second user and the position of the hand of the second user, among the three users, is less than the threshold value, an orientation of the second user may be extracted based on the position of the face of the second user and the position of the hand of the second user, and a sound of the second user may be segmented by segmenting the sound from the orientation extracted from the sounds received from the sensor.

In this instance, the user interface may be controlled based on the segmented sound. Accordingly, in the case of the plurality of users, the user interface may be controlled by identifying a main user who controls the user interface.

A sound corresponding to a sound signature may be segmented from the received sounds, using a database to store the sound signature of the main user who controls the user interface. That is, the user interface may be controlled based on the segmented sound. Accordingly, in the case of the plurality of users, the user interface may be controlled by identifying the main user who controls the user interface.

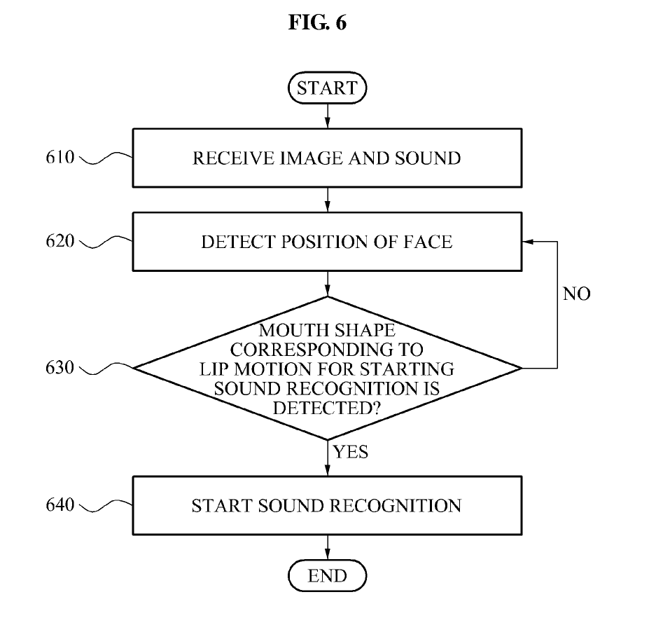

FIG. 6 illustrates a method of controlling a user interface in a case in which a sensor may be mounted in a mobile device according to example embodiments.

Referring to FIG. 6, an image of a user may be received from the sensor in operation 610.

In operation 620, a position of a face of the user may be detected from the received image. In operation 630, a lip motion of the user may be detected based on the detected position of the face.

In operation 640, sound recognition may start when the lip motion of the user corresponds to a lip motion for starting the sound recognition.

The lip motion for starting the sound recognition may be predetermined. Also, the lip motion for starting the sound recognition may be set by the user, by inputting the lip motion in the apparatus for controlling the user interface.

When a change in the detected lip motion is sensed, the sound recognition may start. For example, when an extent of the change in the lip motion exceeds a predetermined criterion value, the sound recognition may start.

That is, the user interface may be controlled based on the sound recognition.

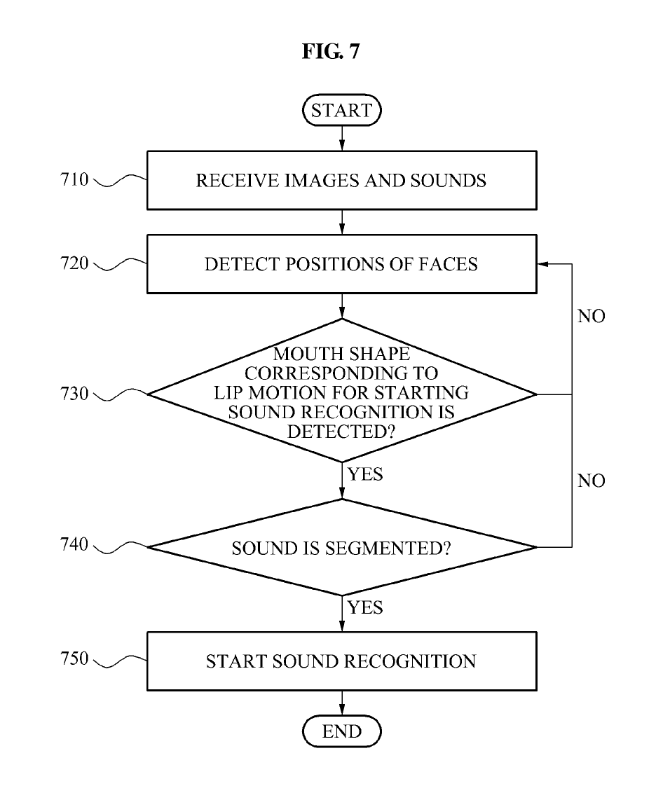

FIG. 7 illustrates a method of controlling a user interface in a case in which a sensor may be mounted in a mobile device, and a plurality of users may be photographed according to example embodiments.

Referring to FIG. 7, images of the plurality of users may be received from the sensor in operation 710. For example, when the sensor photographs three users, images of the three users may be received.

In operation 720, positions of faces of each of the plurality of users may be detected from the received images. For example, a position of a face of a first user, a position of a face of a second user, and a position of a face of a third user, among the three users may be detected from the received images.

In operation 730, lip motions of each of the plurality of users may be detected based on the detected positions of the faces. For example, a lip motion of the first user may be detected from the detected position of the face of the first user, a lip motion of the second user may be detected from the detected position of the face of the second user, and a lip motion of the third user may be detected from the detected position of the face of the third user.

When there is a user having a lip motion corresponding to a lip motion for starting sound recognition, among the plurality of users, the sound recognition may start in operation 750. Also, the user interface may be controlled based on the sound recognition. For example, when the lip motion of the second user, among the three users, corresponds to the lip motion for starting the sound recognition, the sound recognition corresponding to the second user may start. Also, the user interface may be controlled based on the sound recognition corresponding to the second user.

A sound of the user matched to the calculated difference that may be less than the threshold value may be segmented from the received sounds, based on at least one of the to positions of the faces, and the positions of the hands, detected in association with each of the plurality of users.

In particular, an orientation of the user matched to the calculated difference that may be less than the threshold value may be extracted, and a sound may be segmented from the orientation extracted from the sounds received from the sensor, based on at least one of the detected position of the face, and the detected position of the hand, in operation 740. For example, when the difference between the position of the face of the second user and the position of the hand of the second user, among the three users, is less than the threshold value, an orientation of the second user may be extracted based on the position of the face of the second user and the position of the hand of the second user, and a sound of the second user may be segmented by segmenting the sound from the orientation extracted from the sounds received from the sensor.

The method according to the above-described embodiments may be recorded in non-transitory, computer-readable media including program instructions to implement various operations embodied by a computer. The media may also include, alone or in combination with the program instructions, data files, data structures, and the like. Examples of non-transitory, computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus for controlling a user interface, the apparatus comprising:
a reception unit to receive an image of a user from a sensor;
a detection unit to detect a position of a face of the user, and a position of a hand of the user, from the received image;
a processing unit to calculate a difference between the position of the face and the position of the hand; and
a control unit to start sound recognition corresponding to the user when the calculated difference is less than a threshold value, and to control a user interface based on the sound recognition.

2. The apparatus of claim 1, wherein
the detection unit detects a posture of the hand from the received image, and
the control unit starts the sound recognition when the calculated difference is less than the threshold value, and the posture of the hand corresponds to a posture for starting the sound recognition.

3. The apparatus of claim 2, wherein the control unit terminates the sound recognition when the posture of the hand corresponds to a posture for terminating the sound recognition.

4. The apparatus of claim 1, wherein the control unit outputs a visual indicator corresponding to the sound recognition, to a display apparatus associated with the user interface, and starts the sound recognition when the visual indicator is output.

5. The apparatus of claim 1, wherein
the detection detects a gesture of the user from the received image, and
the control unit starts the sound recognition when the calculated difference is less than the threshold value, and the gesture of the user corresponds to a gesture for starting the sound recognition.

6. The apparatus of claim 5, wherein the gesture for starting the sound recognition is predetermined by the user.

7. The apparatus of claim 1, wherein
the control unit outputs one of a posture for starting the sound recognition and a gesture for starting the sound recognition to a display apparatus associated with the user interface,
the sensor senses an image of the user,
the detection unit detects the posture of the hand and the gesture of the user from the received image, and
the control unit starts the sound recognition when the calculated difference is less than the threshold value, and when the detected gesture of the user corresponds to the gesture for starting the sound recognition or the detected posture of the hand corresponds to the posture for starting the sound recognition.

8. The apparatus of claim 1, wherein the control unit terminates the sound recognition corresponding to the user when a sound signal fails to be input within a predetermined time period.

9. The apparatus of claim 1, wherein
the reception unit receives an image of the user from the sensor continuously after the sound recognition is started,
the detection unit detects the posture of the hand and the gesture of the user from the received image, and
the control unit terminates the sound recognition when the detected gesture of the user corresponds to a gesture for terminating the sound recognition or the detected posture of the hand corresponds to a posture for terminating the sound recognition.

10. The apparatus of claim 1, wherein
to the control unit outputs one of a posture for terminating the sound recognition and a gesture for terminating the sound recognition to a display apparatus associated with the user interface after the sound recognition is started,
the sensor senses an image of the user,
the detection unit detects the posture of the hand and the gesture of the user from the received image, and
the control unit terminates the sound recognition when the detected gesture of the user corresponds to the gesture for terminating the sound recognition or the detected posture of the hand corresponds to the posture for terminating the sound recognition.

11. An apparatus for controlling a user interface, the apparatus comprising:
a reception unit to receive images of a plurality of users from a sensor;
a detection unit to detect positions of faces of each of the plurality of users, and positions of hands of each of the plurality of users, from the received images;
a processing unit to calculate differences between the positions of the faces and the positions of the hands, respectively associated with each of the plurality of users; and
a control unit to start sound recognition corresponding to a user matched to a difference that is less than a threshold value when there is a user matched to the difference that is less than the threshold value, among the plurality of users, and to control a user interface based on the sound recognition.

12. The apparatus of claim 11, wherein
the reception unit receives sounds of the plurality of users from the sensor, and
the control unit segments, from the received sounds, a sound of the user having a difference that is less than the threshold value, based on at least one of the positions of the faces, and the positions of the hands, and controls the user interface based on the segmented sound.

13. The apparatus of claim 11, further comprising:
a database to store a sound signature of a main user who controls the user interface,
wherein
the reception unit receives sounds of the plurality of users from the sensor, and
the control unit segments, from the received sounds, a sound corresponding to the sound signature, and controls the user interface based on the segmented sound.

14. An apparatus for controlling a user interface, the apparatus comprising:
a reception unit to receive an image of a user from a sensor;
a detection unit to detect a position of a face of the user from the received image, and to detect a lip motion of the user based on the detected position of the face; and
a control unit to start sound recognition when the detected lip motion corresponds to a lip motion for starting the sound recognition corresponding to the user, and to control a user interface based on the sound recognition.

15. An apparatus for controlling a user interface, the apparatus comprising:
a reception unit to receive images of a plurality of users from a sensor;
a detection unit to detect positions of faces of each of the plurality of users from the received images, and to detect lip motions of each of the plurality of users based on the detected positions of the faces; and
a control unit to start sound recognition when there is a user having a lip motion corresponding to a lip motion for starting the sound recognition, among the plurality of users, and to control a user interface based on the sound recognition.

16. A method of controlling a user interface, the method comprising:
receiving an image of a user from a sensor;
detecting a position of a face of the user, and a position of a hand of the user, from the received image;
calculating a difference between the position of the face and the position of the hand;
starting sound recognition corresponding to the user when the calculated difference is less than a threshold value; and
controlling a user interface based on the sound recognition.

17. A method of controlling a user interface, the method comprising:
receiving images of a plurality of users from a sensor;
detecting positions of faces of each of the plurality of users, and positions of hands of each of the plurality of users, from the received images;
calculating differences between the positions of the faces and the positions of the hands, respectively associated with each of the plurality of users;
starting sound recognition corresponding to a user matched to a difference that is less than a threshold value when there is a user matched to the difference that is less than the threshold value, among the plurality of users; and
controlling a user interface based on the sound recognition.

18. A method of controlling a user interface, the method comprising:
receiving an image of a user from a sensor;
detecting a position of a face of the user from the received image;
detecting a lip motion of the user based on the detected position of the face;
starting sound recognition when the detected lip motion corresponds to a lip motion for starting the sound recognition corresponding to the user; and
controlling a user interface based on the sound recognition.

19. A method of controlling a user interface, the method comprising:
receiving images of a plurality of users from a sensor;
detecting positions of faces of each of the plurality of users from the received images;
detecting lip motions of each of the plurality of users based on the detected positions of the faces;
starting sound recognition when there is a user having a lip motion corresponding to a lip motion for starting the sound recognition, among the plurality of users; and
controlling a user interface based on the sound recognition.

20. A non-transitory computer-readable medium comprising a program for instructing a computer to perform the method of claim 16.
